(19) United States
(12) Patent Application Publication
(10) Pub. No.: US 2024/0271876 A1
(43) Pub. Date: Aug. 15, 2024

(54) HEAT EXCHANGER FOR GAS PHASE POLYMERIZATION

(71) Applicant: Basell Polyolefine GmbH, Wesseling (DE)

(72) Inventors: Pier Luigi Di Federico, Ferrara (IT); Riccardo Rinaldi, Ferrara (IT); Gian Luca Bonaccorsi, Ferrara (IT); Giuseppe Penzo, Mantova (IT); Maurizio Dorini, Ferrara (IT)

(73) Assignee: Basell Polyolefine GmbH, Wesseling (DE)

(21) Appl. No.: 18/568,147

(22) PCT Filed: Jun. 7, 2022
(86) PCT No.: PCT/EP2022/065432

§ 371 Date: Dec. 7, 2023

(30) Foreign Application Priority Data
Jun. 8, 2021 (EP) 21178380.8

(51) Int. Cl. F28D 7/16; C08F 2/34; F28D 1/053; F28F 1/00; F28F 9/02

(52) U.S. Cl. CPC F28D 7/163; C08F 2/34; F28D 1/053; F28F 1/006; F28F 2009/029

(57) ABSTRACT

A multitubular heat exchanger for cooling a gas stream. including an inlet chamber: a bundle of tubes encased in a shell structure: and an outlet chamber, wherein (a) each tube has an inlet with a diameter of d1: a longitudinal middle part with a diameter of d2: an outlet: and (b) d1 is larger than d2.

### FIELD OF THE INVENTION

In general, the present disclosure relates to the field of chemistry. More specifically, the present disclosure relates to polymer chemistry. In particular, the present disclosure relates to a heat exchanger in the gas-phase polymerization of olefins, an apparatus for the gas-phase polymerization of olefins, and a process for preparing an olefin polymer in the apparatus.

### BACKGROUND OF THE INVENTION

In some instances, a heat exchanger transfers heat between two gases or fluids and is used in cooling and heating processes. In some instances, the design is a shell and tube heat exchanger and used in oil refineries and chemical processes operated under high pressure. This type of heat exchanger consists of a shell with a bundle of tubes inside the shell. In some instances, the shell is a pressure vessel. The tubes contain a first fluid for cooling or heating. A second fluid runs over the tubes to heat the tubes or adsorb heat from the tubes, depending on whether the goal is to heat or cool the first fluid.

In some instances, heat exchangers are used in the gas-phase polymerization of olefins. In some instances, gas-phase polymerizations are carried out in fluidized-bed reactors, stirred gas-phase reactors, or multizone circulating reactors with two distinct interconnected gas-phase polymerization zones. In some instances, the components in the gas-phase mixture are made from or containing monomers and comonomers, in the presence of a polymerization catalyst system. In some embodiments, the mixture is further made from or containing polymerization diluents, molecular weight modifiers, or low-molecular weight reaction products. In some instances, the polymerization diluents are nitrogen or alkanes. In some instances, the molecular weight modifier is hydrogen. In some embodiments, the resulting products are solid polyolefin particles.

In some instances, gas is withdrawn from the reaction zone, passed through a heat-exchanger for removing the heat of polymerization, and returned to the polymerization zone. In fluidized-bed reactors, the returned reaction gas further serves to maintain the polyolefin particles in fluidized state. In multizone circulating reactors, the circulation between the reactor zones is effected by the returned reaction gas. In some instances, the recycle lines for the reaction gas are equipped with a centrifugal compressor. In some instances, polymer particles and other solids in the reaction gas cause the equipment, including the heat exchanger, to foul.

In some instances, fouling reduces thermal efficiency, decreases heat flux, increases temperature on the hot side, and decrease temperature on the cold side. In some instances, the accumulation of solids reduces the useful life of the equipment.

### SUMMARY OF THE INVENTION

In a general embodiment, the present disclosure provides a multitubular heat exchanger for cooling a gas stream, including an inlet chamber, a bundle of tubes encased in a shell structure, and an outlet chamber, wherein (a) each tube has an inlet with a diameter of d1, a longitudinal middle part with a diameter of d2, and an outlet, (b) d1 is larger than d2, (c) the inlets of the tubes are integrated into a tube sheet, separating the inlet chamber from the volume within the shell structure, and (d) the upper surface of the tube sheet between two tubes is three-dimensionally shaped, thereby forming an apex in the middle between two neighboring tubes.

In some embodiments, the ratio of d1 to d2 is from 1.75:1 to 1.5:1, alternatively from 1.4:1 to 1.3:1.

In some embodiments, the inlet of each tube has a conical shape.

In some embodiments, d1 is 25 to 45 mm, alternatively 30 to 40 mm.

In some embodiments, d2 is 10 to 30 mm, alternatively 15 to 25 mm.

In some embodiments, the tubes are arranged in a triangular packed pattern within the shell structure.

In some embodiment, the tubes are arranged in a square packed pattern within the shell structure.

In some embodiments, the bundle of tubes includes at least 500, alternatively 500 to 6000, tubes.

In some embodiments, the distance between the middle parts of neighboring tubes is 25 to 45 mm, alternatively 30 to 35 mm, measured from tube axis to tube axis.

In some embodiments, the angle between the cone area and the central axis of the tube is in the range from 20° to 60°, alternatively from 30° to 50°, alternatively 45°.

In some embodiments, the tube sheet has a hole for each tube, wherein the tube is partly received in the respective hole. In some embodiments, the hole tapers out towards the upper surface, forming the inlets of the tubes and forming a pointy apex between neighboring tubes.

In some embodiments, at least the part of the upper surface of the tube sheet is free of flat sections between the holes extending in a plane perpendicular to an axial direction of the tube.

In some embodiments, at least the part of the upper surface of the tube sheet is ribbed, having axially protruding ribs extending between the holes, which taper towards the free end forming the apex.

In some embodiments, the apex confines an angle of 40° to 120°, alternatively from 60° to 100°, alternatively 90°.

In some embodiments, the apex is symmetrical, forming a slope on each side extending to neighboring holes.

In some embodiments, the tubes are welded to the tube sheet inside the respective hole, wherein a fillet weld is formed between a front face of the tube and the inner surface of the hole.

In some embodiments, the inner surface of the tubes, the surfaces of the inlet chamber and the outlet chamber, or both sets of surfaces have a surface roughness Rₐ of less than 7 μm, alternatively less than 3 μm, alternatively less than 2 μm, determined according to ASME B46.1.

In some embodiments, the inner surface of the tubes, the surfaces of the inlet chamber and the outlet chamber, or both sets of surfaces are made of stainless steel.

In some embodiments, the present disclosure provides an apparatus for the gas-phase polymerization of olefins, includes
a reactor made from or containing a polymerization zone:
a recycle line for withdrawing reaction gas from the reactor and feeding the reaction gas back into the reactor:
a compressor for conveying the reaction gas along the recycle line; and
a heat exchanger for cooling the reaction gas.

In some embodiments, the heat exchanger is arranged horizontally or vertically.

In some embodiments, the reactor further includes a butterfly valve arranged downstream of the heat exchanger.

In some embodiments, the reactor is a fluidized-bed reactor.

In some embodiments, the reactor is a multizone circulating reactor, wherein, in a first polymerization zone, growing polyolefin particles flow upwards under fast fluidization or transport conditions, wherein, in a second polymerization zone, growing polyolefin particles flow downward in a densified form, and wherein the first polymerization zone and the second polymerization zone are interconnected, polyolefin particles leaving the first polymerization zone enter the second polymerization zone, and polyolefin particles leaving the second polymerization zone enter the first polymerization zone, thereby establishing a circulation of polyolefin particles through the first and second polymerization zones.

In some embodiments, the reactor is part of a series of reactors.

In some embodiments, the present disclosure provides a process for preparing an olefin polymer including the step of homopolymerizing an olefin or copolymerizing an olefin and one or more other olefins at temperatures from 20 to 200° C. and pressures of 0.5 to 10 MPa, in the presence of a polymerization catalyst.

In some embodiments, the process is carried out at a reaction gas stream velocity of from 5 m/s to 25 m/s, alternatively from 15 m/s to 20 m/s.

### BRIEF DESCRIPTION OF THE DRAWINGS

FIG. 1a shows a schematic of a heat exchanger.

FIG. 1b shows a schematic of a heat exchanger.

FIG. 1c shows a schematic of a heat exchanger.

FIG. 2 shows a schematic of an apparatus including a fluidized bed reactor and a heat exchanger, for carrying out a process for preparing an olefin polymer.

FIG. 3 shows a schematic of an apparatus including a multizone circulating reactor and a heat exchanger, for carrying out a process for preparing an olefin polymer.

### DETAILED DESCRIPTION OF THE INVENTION

In some embodiments, the present disclosure provides a heat exchanger for cooling a gas stream, including an inlet chamber, a bundle of tubes encased in a shell structure, and an outlet chamber, wherein each tube has an inlet, a longitudinal middle part, and an outlet. In some embodiments, the heat exchanger is a one-pass straight-tube heat exchanger. In some embodiments, the tubes, which are passed by the gas to be cooled, are fully surrounded by a circulating cooling medium. In some embodiments and for providing mechanical stability, the tubes of the heat exchanger are fixedly connected to tube sheets, separating the inlet chamber and the outlet chamber from the volume within the shell structure filled with the circulating cooling medium. In some embodiments, an end of each tube is put through holes in the tubes sheets before being fixedly connected to the tube sheets.

In some instances of gas-phase polymerization processes, polymer particles or other solids are entrained in the gas stream to be cooled which passes through the tubes of the heat exchanger. In some instances, solid particles accumulate in the heat exchanger, thereby fouling the equipment. In some embodiments, the heat exchanger of the present disclosure avoids dead zones where solid particles accumulate, polymerize, grow, and plug the heat exchanger.

In some embodiments, the diameter dl of the inlet of each tube is larger than the diameter d2 of the corresponding longitudinal middle part of the tube. Without being bound to any theory, it is believed that solid particles entrained in the gas stream are swept into the pipes and carried back into the reactor for further polymerization and growth. In some embodiments, the ratio of the dimeter dl to the diameter d2 is in the ratio from 1.75:1 to 1.5:1, alternatively from 1.4:1 to 1.3:1. In some embodiments, the inlet of each tube has a conical shape. In some embodiments, the angle between the cone area and the central axis of the tube is in the range from 20° to 60°, alternatively from 30° to 50°, alternatively 45°. In some embodiments, the conical shape of the inlet part of the tube is prepared using a grinding tool, alternatively a rotating grinding tool having a conical shape. In some embodiments, the cone angle of the rotating grinding tool is in the range from 40° to 120°, alternatively from 60° to 100°, alternatively 90°. In some embodiments, the slope of the inlet of the tubes is designed such that solid particles do not stop on the inlet's surface and are swept into the tube.

In some embodiments, the inlet of each tube has a diameter dl of from 25 mm to 45 mm, alternatively from 30 mm to 40 mm. As used herein, the term “inlet diameter” refers to the inner diameter and is defined for the inlets of the tubes as any straight line segment that passes through the center of the circle defined by the periphery of the tube inlet at inlet's broadest expansion and whose end points lay in the circle. In some embodiments, the diameter d2 of the longitudinal middle part of each tube, that is, the inner diameter of the longitudinal middle part of each tube, is from 10 mm to 30 mm, alternatively from 15 to 25 mm, with the diameter as defined above and determined at the broadest expanse of the middle part of the tube. In some embodiments, the longitudinal middle part of the tubes has a constant diameter.

In some embodiments, the tubes of the heat exchanger are arranged in the form of a bundle encased in a shell structure. In some embodiments, the tubes are arranged within the bundle for providing efficient utilization of space and room for the cooling medium to pass around the tubes. In some embodiments, the tubes are arranged in a regular manner, alternatively in a square packed pattern or a triangular packed pattern. In some embodiments, the tubes are arranged within the shell structure in a triangular packed pattern. In some embodiments, the bundle of tubes encased in the shell structure includes at least 500 tubes, alternatively from 500 to 6000 tubes.

In some embodiments, the distance between the outsides of the tubes , defining the space occupied by the cooling medium, is not below 5 mm. In some embodiments, the distance between the middle parts of neighboring tubes is from 25 to 45 mm, alternatively from 30 to 35 mm, measured from tube axis to tube axis, respectively, with the axis passing through the center of the tubes along the longitudinal direction of the tube.

In some embodiments, the inlets of the tubes of the heat exchanger are integrated in the tube sheet separating the inlet chamber from the volume within the shell structure. In some embodiments, the inlets of the tubes have a conical form, formed by partly removing tube sheet material, such that the upper surface of the tube sheet between two tubes is three-dimensionally shaped. The tube sheet forms an apex in the middle between two neighboring tubes.

As used herein, the term “the upper surface” of the tube sheet refers to the surface of the tube sheet facing upstream. Consequently, the upper surface of the tube sheet faces away from the volume within the shell structure and is exposed to the gas stream, alternatively the solids in the gas stream.

In some embodiments, the tube sheet includes holes for each tube, wherein the tube is partly received in the respective hole and wherein the hole tapers out towards the upper surface, thereby forming the inlets of the tubes and a pointy apex between neighboring tubes. In some embodiments, the apex is symmetrical and confines an angle of from 40° to 120°, alternatively from 60° to 100°, alternatively 90° . In some embodiments, each side of the apex forms a slope extending into the hole and leading towards the respective tube received in the hole. In some embodiments, the inlets are formed by sloped surface of the hole.

In some embodiments, the hole tapers out towards the upper surface, starting from a height beyond a front end of the tube, received in the hole.

In some embodiments, the tubes are partly received in the respective holes, wherein the tubes do not extend through the entirety of the hole. In some embodiments, a gap is provided between the upper surface of the tube sheet and the front end of the tube. In some embodiments, the tube is welded to the tube sheet. In some embodiments, a fillet weld seam is formed between the front end of the tube and an inner surface of the hole. In some embodiments, the fillet weld seam forms a sloped surface along which particles glide into the tube. In some embodiments, the fillet weld seam forms a continuation of the slope leading to the apex formed in the tube sheet.

In some embodiments, at least the part of the upper surface of the tube sheet, which comes into contact with the gas flow, is free of flat sections extending in a plane perpendicular to an axial direction of the tube.

Due to the apex formed on the upper surface between two neighboring tubes, solid particles slide off the sloped surfaces forming the apex and are guided into the tubes of the heat exchanger. Accumulation of the solid particles on the upper surface is thus prevented. In some embodiments, the heat exchanger is deployed in gas-phase polymerization apparatuses without a gas/solid separation device such as a cyclone. In some embodiments, the recycle line is not equipped with a cyclone. In some embodiments, the recycle line is not equipped with a cyclone upstream of the compressor, the heat-exchanger, or both.

In some embodiments, the inner surface of the tubes, the surface of connectors, or both sets of surfaces have a surface roughness Rₐ of less than 7 μm, alternatively less than 3 um, alternatively less than 2 μm, determined according to ASME B46.1. In some embodiments, there is a constant and homogenous gas flow through the heat exchanger. In some embodiments, the surface(s) are made from or containing stainless steel, thereby providing an inert material for withstanding the reaction conditions of gas-phase polymerization. In some embodiments, the inner surface of the tubes, the surface of the connectors, or both sets of surfaces are made from or containing stainless steel. In some embodiments, the stainless steel is AISI 304 Stainless Steel.

In some embodiments, the heat exchanger is free protrusions on the surfaces coming into contact with the reaction gas exceeding a height of 1.5 mm. In some embodiments, the protrusions originate from welding together elements of the heat exchanger.

In some embodiments, the present disclosure provides an apparatus for the gas-phase polymerization of olefins. In some embodiments, the apparatus includes a reactor having a polymerization zone, a recycle line for withdrawing reaction gas from the reactor and feeding the reaction gas back into the reactor, a compressor for conveying the reaction gas along the recycle line, and a heat exchanger for cooling the reaction gas.

In some embodiments, the heat exchanger is arranged at various positions of the recycle line. In some embodiments, the heat exchanger is arranged horizontally or vertically. In some embodiments, the heat exchanger is arranged vertically.

In some embodiments, the reactor further includes a butterfly valve arranged downstream of the heat exchanger. In some embodiments, the butterfly valve controls the flow rate of the gas stream, thereby establishing a variable pressure drop in the recycle line while the device has a low risk for fouling.

In some embodiments, the recycling loop is further equipped with a cyclone upstream of the compressor and the heat exchanger, thereby minimizing carry-over of solid particles.

In some embodiments, the reactor is a fluidized-bed reactor. Fluidized-bed reactors are reactors, wherein the polymerization takes place in a bed of polyolefin particles which is maintained in a fluidized state by feeding a reaction gas mixture into a reactor at the lower end of the reactor and withdrawing the gas again at the top of the fluidized-bed reactor. In some instances, the reaction gas mixture is fed into the reactor below a gas distribution grid, having the function of dispensing the gas flow. The reaction gas mixture is then returned to the lower end of the reactor via a recycle line equipped with a compressor and a heat exchanger for removing the heat of polymerization. The flow rate of the reaction gas fluidizes the bed of finely divided polymer particles in the polymerization zone and removes the heat of polymerization. In some embodiments, the reactors are as described in Patent Cooperation Treaty Publication No. WO 2007/071527 A1.

In some embodiments, the reactor is a multizone circulating reactor, wherein, in a first polymerization zone, growing polyolefin particles flow upward under fast fluidization or transport conditions, wherein, in a second polymerization zone, growing polyolefin particles flow downward in a densified form, and wherein the first polymerization zone and the second polymerization zone are interconnected, polyolefin particles leaving the first polymerization zone enter the second polymerization zone, and polyolefin particles leaving the second polymerization zone enter the first polymerization zone, thereby establishing a circulation of polyolefin particles through the first and second polymerization zone.

In some embodiments, the multizone circulating reactors are as described in Patent Cooperation Treaty Publication Nos. WO 97/04015 A1 and WO 00/02929 A1. In some embodiments, the multizone circulating reactors have two interconnected polymerization zones: (i) a riser, wherein the growing polyolefin particles flow upward under fast fluidization or transport conditions, and (ii) a downcomer, wherein the growing polyolefin particles flow downward in a densified form under the action of gravity. The polyolefin particles leaving the riser enter the downcomer, and the polyolefin particles leaving the downcomer are reintroduced into the riser, thereby establishing a circulation of polymer between the two polymerization zones. In some embodiments, the polymer is passed alternately a plurality of times through these two zones. In such polymerization reactors, a solid/gas separator is arranged above the downcomer to separate the polyolefin and reaction gaseous mixture coming from the riser. The growing polyolefin particles enter the downcomer, and the separated reaction gas mixture of the riser is continuously recycled through a gas recycle line to one or more points of reintroduction into the polymerization reactor. In some embodiments, the larger part of the recycle gas is recycled to the bottom of the riser. The recycle line is equipped with a centrifugal compressor and a heat exchanger for removing the heat of polymerization. In some embodiments, a line for feeding catalyst or a line for feeding polyolefin particles coming from an upstream reactor is arranged at the riser and a polymer discharge system is located in the bottom portion of the downcomer. In some embodiments, make-up monomers, comonomers, hydrogen or inert components are introduced at various points along the riser and the downcomer.

In some embodiments, the reactor is part of a series of reactors. In some embodiments, the series includes a first gas-phase apparatus and a subsequent second gas-phase apparatus.

In some embodiments, the present disclosure provides a process for preparing an olefin polymer including the step of homopolymerizing an olefin or copolymerizing an olefin and one or more other olefins at temperatures from 20 to 200° C. and pressures from 0.5 to 10 MPa, in the presence of a polymerization catalyst.

In some embodiments, the process is for the polymerization of olefins, alternatively 1-olefins. As used herein, the term “1-olefins” refers to hydrocarbons having terminal double bonds, without being restricted thereto. In some embodiments, the olefins are nonpolar olefinic compounds. In some embodiments, the 1-olefins are linear C₂-C₁₂-1-alkenes, branched C₂-C₁₂-1-alkenes, conjugated dienes, or nonconjugated dienes. In some embodiments, the linear alkenes are C₂-C₁₀-1-alkenes. In some embodiments, the linear C₂-C₁₀-1-alkenes are selected from the group consisting of ethylene, propylene, 1-butene, 1-pentene, 1-hexene, 1-heptene, 1-octene, and 1-decene. In some embodiments, the branched alkenes are C₂-C₁₀-1-alkenes. In some embodiments, the branched C₂-C₁₀-1-alkene is 4-methyl-1-pentene. In some embodiments, the dienes are selected from the group consisting of 1,3-butadiene, 1,4-hexadiene, and 1,7-octadiene. In some embodiments, mixtures of various 1-olefins are polymerized. In some embodiments, the olefins have the double bond as part of a cyclic structure. In some embodiments, the cyclic structure has one or more ring systems. In some embodiments, the olefins, including a cyclic structure, are selected from the group consisting of cyclopentene, norbornene, tetracyclododecene, methylnorbornene, 5-ethylidene-2-norbornene, norbornadiene, and ethylnorbornadiene.

In some embodiments, the apparatuses are for the homopolymerization or copolymerization of ethylene or propylene, alternatively for the homopolymerization or copolymerization of ethylene. In some embodiments, comonomers in propylene polymerization are up to 40 wt. % of ethylene, 1-butene, or 1-hexene, alternatively from 0.5 wt. % to 35 wt. % of ethylene, 1-butene and/or 1-hexene. In some embodiments, comonomers in ethylene polymerization are up to 20 wt. %, alternatively from 0.01 wt. % to 15 wt. %, alternatively from 0.05 wt. % to 12 wt. % of C3-C8-1-alkenes. In some embodiments, the alkene is selected from the group consisting of 1-butene, 1-pentene, 1-hexene, and 1-octene. In some embodiments, ethylene is copolymerized with from 0.1 wt. % to 12 wt. % of 1-hexene or 1-butene.

In some embodiments, the process is carried out at pressures of from 0.5 MPa to 10 MPa, alternatively from 1.0 MPa to 8 MPa, alternatively from 1.5 MPa to 4 MPa. As used herein, pressures refer to absolute pressures, that is, pressure having the dimension MPa (abs). In some embodiments, the polymerization is carried out at temperatures of from 30° C. to 160° C., alternatively from 65° C. to 125° C. In some embodiments and for preparing ethylene copolymers of relatively high density, the temperatures are in the upper part of the range. In some embodiments and for preparing ethylene copolymers of lower density, the temperatures are in the lower part of the range.

In some embodiments, the process is carried out in a condensing or super-condensing mode, wherein part of the circulating reaction gas mixture is cooled to below the dew point and returned to the reactor (a) separately as a liquid and a gas or (b) together as a liquid-gas phase mixture, thereby making additional use of the enthalpy of vaporization for cooling the reaction gas. In some embodiments, the process is operated in a condensing or super-condensing mode and carried out in a fluidized-bed reactor.

In some embodiments, the polymerization is carried out in the presence of an inert gas such as nitrogen or an alkane having from 1 to 10 carbon atoms. In some embodiments, the alkane is selected from the group consisting of methane, ethane, propane, n-butane, isobutane, n-pentane, isopentane, n-hexane, and mixtures thereof. In some embodiments, the inert gas is nitrogen or propane. In some embodiments, nitrogen or propane is used in combination with further alkanes. In some embodiments, the polymerization is carried out in the presence of a C₃-C₅ alkane as polymerization diluent, alternatively in the presence of propane. In some embodiments, the polymerization is for the homopolymerization or copolymerization of ethylene. In some embodiments, the reaction gas mixtures within the reactor are made from or containing the olefins to be polymerized and one or more optional comonomers. In some embodiments, the reaction gas mixture has a content of inert components from 30 to 99 vol. %, alternatively from 40 to 95 vol. %, alternatively from 45 to 85 vol. %. In some embodiments, no or only minor amounts of inert diluent are added. In some embodiments, the monomer to be polymerized is propylene. In some embodiments, the reaction gas mixture is further made from or containing additional components or molecular weight regulators. In some embodiments, the additional components are antistatic agents. In some embodiments, the molecular weight regulator is hydrogen. In some embodiments, the components of the reaction gas mixture are fed into the gas-phase polymerization reactor or into the recycle line in gaseous form or as liquid which then vaporizes within the reactor or the recycle line.

In some embodiments, the polymerization of olefins is carried out using olefin polymerization catalysts. In some embodiments, the polymerization is carried out using Phillips catalysts based on chromium oxide, using Ziegler- or Ziegler-Natta-catalysts, or using single-site catalysts. As used herein, the term “single-site catalysts” refers to catalysts based on chemically uniform transition metal coordination compounds. In some embodiments, mixtures of two or more of these catalysts are used for the polymerization of olefins. In some embodiments, mixed catalysts are referred to as hybrid catalysts.

In some embodiments, the catalysts are of the Ziegler type. In some embodiments, the catalysts of the Ziegler or Ziegler-Natta type are made from or containing a compound of titanium or vanadium, a compound of magnesium and optionally an electron donor compound or a particulate inorganic oxide as a support material.

In some embodiments, catalysts of the Ziegler type are polymerized in the presence of a cocatalyst. In some embodiments, the cocatalysts are organometallic compounds of metals of Groups 1, 2, 12, 13 or 14 of the Periodic Table of Elements, alternatively organometallic compounds of metals of Group 13, alternatively organoaluminum compounds. In some embodiments, the cocatalysts are selected from the group consisting of organometallic alkyls, organometallic alkoxides, and organometallic halides.

In some embodiments, the organometallic compounds are selected from the group consisting of lithium alkyls, magnesium alkyls, zinc alkyls, magnesium alkyl halides, aluminum alkyls, silicon alkyls, silicon alkoxides, and silicon alkyl halides. In some embodiments, the organometallic compounds are selected from the group consisting of aluminum alkyls and magnesium alkyls. In some embodiments, the organometallic compounds are aluminum alkyls, alternatively trialkylaluminum compounds or compounds of this type wherein an alkyl group is replaced by a halogen atom. In some embodiments, the halogen atom is chlorine or bromine. In some embodiments, the aluminum alkyls are selected from the group consisting of trimethylaluminum, triethylaluminum, tri-isobutylaluminum, tri-n-hexylaluminum, diethylaluminum chloride, and mixtures thereof.

In some embodiments, the catalysts are Phillips-type chromium catalysts. In some embodiments, the Phillips-type chromium catalysts are prepared by applying a chromium compound to an inorganic support and subsequently activating the obtained catalyst precursor at temperatures in the range from 350 to 1000° C., thereby converting chromium present in valences lower than six into the hexavalent state. In some embodiments, an element other than chromium is used and selected from the group consisting of magnesium, calcium, boron, aluminum, phosphorus, titanium, vanadium, zirconium, and zinc. In some embodiments, the element is selected from the group consisting of titanium, zirconium, and zinc. In some embodiments, the elements are used in combinations. In some embodiments, the catalyst precursor is doped with fluoride prior to or during activation. In some embodiments, supports for Phillips-type catalysts are made from or containing aluminum oxide, silicon dioxide (silica gel), titanium dioxide, zirconium dioxide, mixed oxides thereof, cogels thereof, or aluminum phosphate. In some embodiments, support materials are obtained by modifying the pore surface area. In some embodiments, the pore surface area is modified using compounds of the elements boron, aluminum, silicon, or phosphorus. In some embodiments, the pore surface area is modified using a silica gel. In some embodiments, the pore surface area is modified using spherical or granular silica gels. In some embodiments, the spherical silica gels are spray dried. In some embodiments, the activated chromium catalysts are subsequently prepolymerized or prereduced. In some embodiments, the prereduction is carried out with cobalt or hydrogen at 250° C. to 500° C., alternatively at 300° C. to 400° C., in an activator.

In some embodiments, the polymerization occurs in a gas-phase reactor which is part of a cascade of polymerization reactors. In some embodiments, one or more polymerizations occur in other gas-phase reactors of the cascade of polymerization reactors. In some embodiments, the combinations of polymerizations reactors are selected from the group consisting of a fluidized-bed reactor followed by a multizone circulating reactor, a multizone circulating reactor followed by a fluidized-bed reactor, a cascade of two or three fluidized-bed reactors, and one or two loop reactors followed by one or two fluidized-bed reactors.

In some embodiments, the process is carried out at a reaction gas stream velocity of from 5 m/s to 25 m/s, alternatively from 15 m/s to 20 m/s.

In some embodiments, the fluidization velocity in the polymerization zone is 0.3 to 1.5 m/s, alternatively 0.5 to 1.2 m/s. FIG. la shows a schematic of a heat exchanger.

Heat exchanger (6) has an inlet chamber (61), a bundle of tubes (62) encased in a shell structure, and an outlet chamber (63). The inlet chamber (61) and the outlet chamber (63) are separated from the shell structure filled with cooling medium by tube sheets (64) and (65).

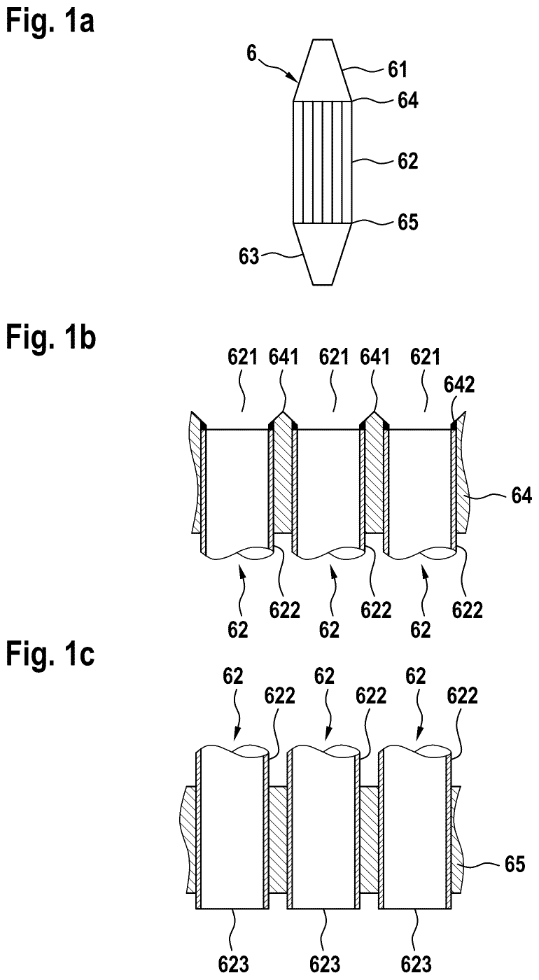

FIG. 1b shows a schematic of a heat exchanger. FIG. 1c shows a schematic of a heat exchanger.

FIG. 1b shows a cross section through the inlets of three tubes (62) of the heat exchanger (6). Shown are the conical inlets (621) of the tubes (62) and upper regions of the longitudinal middled parts (622) of the tubes (62). The tubes (62) are fastened within the heat exchanger (6) by being fixedly connected to tube sheet (64) at the upper ends of the tubes (62). The conical inlets (621) of the tubes (62) were formed by partly removing tube sheet material, such that the upper surface of tube sheet (64) between two tubes (62) is three-dimensionally shaped and forms an apex (641) in the middle between two neighboring tubes (62). The ends of the tubes (62) are welded to the tubes (62), forming a fillet shaped weld seam (642). In some instances, the fillet weld extends from a front end of the tubes (62) to an inner surface of the respective holes formed on the tube sheet. In some instances, the fillet weld seam (642) forms a continuation of the slope leading to the apex (641).

FIG 1c shows a cross section through the outlets of three tubes (62) of the heat exchanger (6). Shown are the even outlets (623) of the tubes (62) and lower regions of the longitudinal middled parts (622) of the tubes (62). The tubes (62) are fastened within the heat exchanger (6) by being fixedly connected to tube sheet (65) at the lower ends of the tubes (62). The outlets (623) of the tubes (62) are arrange slightly below the lower surface of tube sheet (65).

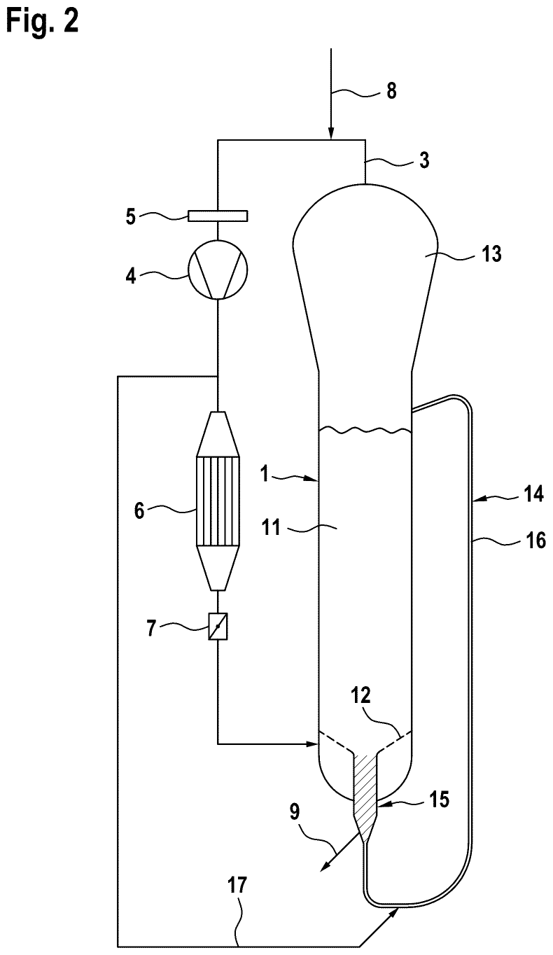

FIG. 2 shows a schematic of an apparatus, including a fluidized bed reactor and a heat exchanger, for carrying out a process for preparing an olefin polymer.

Fluidized-bed reactor (1) includes a fluidized bed (11) of polyolefin particles, a gas distribution grid (12), and a velocity reduction zone (13) having an increased diameter compared to the diameter of the fluidized bed portion of the reactor. The polyolefin bed is kept in a fluidization state by an upwardly flow of gas fed through the gas distribution grid (12) placed at the bottom of reactor (1). The gaseous stream of the reaction gas leaving the top of the velocity reduction zone (13) via the recycle line (3) is compressed by the compressor (4) having variable guide vanes (5), transferred to a heat exchanger (6), wherein the reaction gas is cooled, and then recycled to the bottom of the fluidized-bed reactor (1) at a point below the gas distribution grid (12). The recycle line (3) further has, downstream from the heat exchanger (6), a butterfly valve (7). In some instances, make-up monomer, molecular weight regulators, and optional inert gases or process additives are fed into the reactor (1) at various positions. In some embodiments, the components are fed via line (8) upstream of the compressor (4).

The fluidized-bed reactor (1) is provided with a continuous pneumatic recycle of polyolefin particles by a circulation loop (14), connecting the gas distribution grid (12) to the upper region of the fluidized-bed reactor (1). The circulation loop (14) includes a settling pipe (15) and a pneumatic conveyor pipe (16). The upper opening of the settling pipe (15) is integrated with the gas distribution grid (12). In some instances, the settling pipe is arranged vertical. The gas distribution grid (12) has a cone shape, such that the cone's downward inclination towards the settling pipe (15) fosters the entry of the polyolefin particles into the settling pipe (15) due to gravity. In some instances, the upper opening of the settling pipe (15) is located in a central position with respect to the gas distribution grid (12). The carrier gas fed via line (17) for transporting the polyolefin particles through the pneumatic conveyor pipe (16) is taken from the gas recycle line at a point downstream of the compressor (4) and upstream the heat exchanger (6). The discharge of polyolefin particles from the fluidized-bed reactor (1) occurs from the settling pipe (15) through discharge conduit (9).

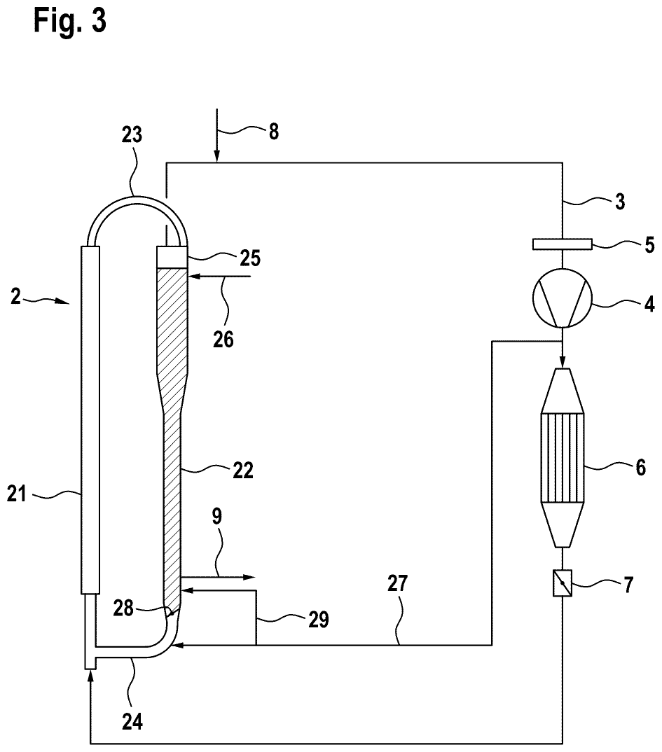

FIG. 3 shows a schematic of an apparatus, including a multizone circulating reactor and a heat exchanger, for carrying out a process for preparing an olefin polymer

The multizone circulating reactor (2) includes a riser (21) as first reaction zone and a downcomer (22) as second reaction zone. The riser (21) and the downcomer (22) are repeatedly passed by the polyolefin particles. Within riser (21), the polyolefin particles flow upward under fast fluidization conditions. Within the downcomer (22), the polyolefin particles flow downward under the action of gravity. The riser (21) and the downcomer (22) are appropriately interconnected by interconnection bends (23) and (24).

After flowing through the riser (21), the polyolefin particles and the reaction gas mixture leave riser (21) and are conveyed to a solid/gas separation zone (25). In some instances, the solid/gas separation is effected by a centrifugal separator. In some instances, the centrifugal separator is a cyclone. From separation zone (25), the polyolefin particles move downwards into the downcomer (22). In some instances, a barrier fluid for preventing the reaction gas mixture of the riser (21) from entering the downcomer (22) is fed into a top part of the downcomer (22) via line (26).

The reaction gas mixture leaving the separation zone (25) is recycled to the bottom of the riser (21) by a recycle line (3), equipped with a compressor (4), having variable guide vanes (5), thereby establishing fast fluidization conditions in the riser (21). The recycle line (3) further includes a heat exchanger 6) and a butterfly valve (7) downstream of heat exchanger (6). In some instances, make-up monomers, make-up comonomers, and optionally inert gases or process additives are fed into the reactor (2) at various positions. In some instances, the components are fed via line (8) into the recycle line (3). Between the compressor (4) and the heat exchanger (6), a line (27) branches off and conveys a part of the recycle gas into the interconnection bend (24) for transporting the polyolefin particle from the downcomer (22) to riser (21).

The bottom of the downcomer (22) is equipped with a butterfly valve (28), having an adjustable opening for adjusting the flow of polyolefin particles from downcomer (22) through interconnection bend (24) into the riser (21). Above the butterfly valve (28), amounts of a recycle gas mixture coming from the recycle line (3) through lines (26) and (29) are introduced as dosing gas into the downcomer (22), thereby facilitating the flow of the polyolefin particles through butterfly valve (28). The discharge of polyolefin particles from the multizone circulating reactor (2) occurs from the downcomer (22) through discharge conduit (9).

1. A multitubular heat exchanger for cooling a gas stream, comprising:
an inlet chamber;
a bundle of tubes encased in a shell structure; and
an outlet chamber,
wherein
(a) each tube comprises:
an inlet with a diameter of d1;
a longitudinal middle part with a diameter of d2; and
an outlet;
(b) d1 is larger than d2;
(c) the inlets of the tubes are integrated into a tube sheet, separating the inlet chamber from the volume within the shell structure; and
(d) the upper surface of the tube sheet between two tubes is three-dimensionally shaped, thereby forming an apex in the middle between two neighboring tubes.

2. The heat exchanger of claim 1, wherein the ratio of d1 to d2 is from 1.75:1 to 1.5:1.

3. The heat exchanger of claim 1, wherein the inlet of each tube has a conical shape.

4. The heat exchanger of claim 1, wherein d1 is 25 to 45 mm.

5. The heat exchanger of claim 1, wherein d2 is 10 to 30 mm.

6. The heat exchanger of claim 1, wherein the bundle of tubes comprises at least 500.

7. The heat exchanger of claim 1, wherein the distance between the middle parts of neighboring tubes is 25 to 45 mm, measured from tube axis to tube axis.

8. The heat exchanger of claim 1, wherein the angle between the cone area and the central axis of the tube is in the range from 20° to 60°.

9. The heat exchanger of any of the previous claim 1, wherein the tube sheet comprises a hole for each tube, wherein the tube is partly received in the respective hole, and wherein the hole at least partly tapers out towards the upper surface, forming the inlets of the tubes and forming a pointy apex between neighboring tubes.

10. The heat exchanger of claim 1, wherein the inner surface of the tubes the surfaces of the an-inlet chamber and the outlet chamber, or both sets of surfaces have a surface roughness Rₐ of less than 7 μm, determined according to ASME B46.1.

11. An apparatus for the gas-phase polymerization of olefins, comprising:
a reactor comprising a polymerization zone;
a recycle line for withdrawing reaction gas from the reactor and feeding the reaction gas back into the reactor;
a compressor for conveying the reaction gas along the recycle line; and
a heat exchanger for cooling the reaction gas, wherein the heat exchanger is the heat exchanger of claim 1.

12. The apparatus of claim 11 further comprising a butterfly valve arranged downstream of the heat exchanger.

13. The apparatus of claim 11, wherein the reactor is a fluidized-bed reactor.

14. The apparatus of claim 11, wherein the reactor is a multizone circulating reactor, wherein, in a first polymerization zone, growing polyolefin particles flow upwards under fast fluidization or transport conditions, wherein, in a second polymerization zone, growing polyolefin particles flow downward in a densified form, and wherein the first polymerization zone and the second polymerization zone are interconnected, polyolefin particles leaving the first polymerization zone enter the second polymerization zone, and polyolefin particles leaving the second polymerization zone enter the first polymerization zone, thereby establishing a circulation of polyolefin particles through the first and second polymerization zones.

15. A process for preparing an olefin polymer comprising the step of:
homopolymerizing an olefin or copolymerizing an olefin and one or more other olefins at temperatures from 20 to 200° C. and pressures of 0.5 to 10 MPa, in the presence of a polymerization catalyst, wherein the process is carried out in the apparatus of any of claim 11.

16. The heat exchanger of claim 1, wherein the apex confines an angle of 40° to 120°.

17. The heat exchanger of claim 9, wherein the apex is symmetrical, forming a slope on each side extending to the neighboring holes.

18. The heat exchanger of claim 9, wherein each tube is welded to the tube sheet inside the respective hole, and wherein a fillet weld is formed between a front face of the tube and an inner surface of the respective hole.

19. The apparatus of claim 11, wherein the reactor is part of a series of reactors.

20. The process of claim 15, wherein the process is carried out at a reaction gas stream velocity of from 5 m/s to 25 m/s.
